(19) United States
(12) Patent Application Publication
(10) Pub. No.: US 2018/0058078 A1
(43) Pub. Date: Mar. 1, 2018

(54) FLAME-RETARDANT DECORATIVE FLOORING MATERIAL AND METHOD OF MANUFACTURING THE SAME (AS AMENDED)

(71) Applicant: LG HAUSYS, LTD., Seoul (KR)

(72) Inventors: Hyun Jong KWON, Ulsan (KR); Suk Je SON, Ulsan (KR); Jae Wan SUNG, Ulsan (KR); Jong dae PARK, Ulsan (KR); Kwang Sug Yang, Seoul (KR); Ung Kil KIM, Seongnam-si, Gyeonggi-do (KR); Jun Young KIM, Namyangju-si, Gyeonggi-do (KR)

(21) Appl. No.: 15/552,762

(22) PCT Filed: Mar. 30, 2015
(86) PCT No.: PCT/KR2015/003091

§ 371 Date: Aug. 22, 2017

(30) Foreign Application Priority Data
Mar. 12, 2015 (KR) 10-2015-0034194

(51) Int. Cl. E04F 15/10; B32B 5/02; B32B 17/06; B32B 27/08; B32B 27/30; B32B 27/36; C08F 118/08; C08K 3/26

(52) U.S. Cl. CPC E04F 15/105; E04F 15/107; B32B 5/022; B32B 17/064; B32B 37/10; B32B 27/304; B32B 27/36; C08F 118/08; C08K 3/26; B32B 27/08

(57) ABSTRACT

The present invention relates to a flame-retardant decorative flooring material including a lower layer; a base layer; a printed layer; and a transparent layer sequentially from bottom to top, wherein at least any one of the layers includes a polyvinyl acetal resin. In addition, the present invention relates to a method of manufacturing a flame-retardant decorative flooring material including a lower layer; a base layer; a printed layer; and a transparent layer sequentially from bottom to top, the method including (1) a lower layer preparation step of preparing a lower layer using a composition including 100 parts by weight of a polyvinyl acetal resin and 100 to 400 parts by weight of a filler based on 100 parts by weight of the polyvinyl acetal resin; (2) a base layer preparation step of preparing a base layer composed of glass fiber that is immersed in a PVC sol; (3) a printing step of forming a printed layer by printing a pattern on the base layer or laminating the base layer with a pattern-printed film or paper; (4) a transparent layer preparation step of preparing a transparent layer composed of a transparent PVC film or a PET film; and (5) a lamination step of disposing the base layer including the printed layer formed thereon between the lower layer and the transparent layer and laminating the same.

### TECHNICAL FIELD

The present invention relates to a flame-retardant decorative flooring material and a method of manufacturing the same. More particularly, the present invention relates to a flame-retardant decorative flooring material and a method of manufacturing the same wherein at least any one of layers constituting the flame-retardant decorative flooring material includes a polyvinyl acetal resin, thereby providing safety and superior flame retardancy by reducing the density of flame and toxic gases generated by combustion of resin in case of fire.

### BACKGROUND ART

Recently, interest in eco-friendly products as well as health is increasing with improvement in quality of life. For example, conventional decorative flooring materials, which are closely related to residential life, are gradually being replaced by eco-friendly materials. In addition, regulations on raw materials and the like used to manufacture such decorative flooring materials are being strengthened.

Flame retardancy is best in decorative flooring materials to which a rubber raw material is added, but there are difficulties in application of the rubber raw material due to high cost thereof. Accordingly, a PVC raw material, which exhibits insufficient flame retardancy but is cheap, is widely used in manufacturing decorative flooring materials.

FIG. 1 is a sectional view illustrating the constitution of a conventional general PVC decorative flooring material. This PVC decorative flooring material includes, from bottom to top, a lower layer 100, a base layer 200, and a transparent layer 300.

However, in the lower layer 100, the transparent layer 300 and the like of the conventional decorative flooring material, a PVC material is used as a raw material thereof. In the case of the conventional decorative flooring material, flame slowly propagates in case of fire due to a halogen element contained therein, but a lot of smoke is generated. In addition, the conventional decorative flooring material includes a toxic phthalate-based plasticizer, releases harmful substances, such as environmental hormones and toxic gases (hydrogen chloride), upon incineration or in case of fire, and almost permanently remains in the natural environment upon landfill disposal, resulting in a heavy environmental burden.

Particularly, when a flooring material made of a PVC raw material is used for a ship, a train, or an automobile, the amount of smoke is large in case of fire and secondary disasters, such as suffocation, in case of fire or fire suppression due to toxicity caused by gas may occur. Accordingly, a composition used to manufacture a decorative flooring material is required to have flame retardancy, such as non-toxicity and less smoke, and is being regulated and standardized by the law.

Therefore, there is a high demand for development of a decorative flooring material and the like having superior flame retardancy.

As an example of a conventional PVC flooring material, KR 10-2004-0065494 A is provided.

### RELATED ART DOCUMENT

### Patent Document

[Patent Document 1] KR 10-2004-0065494 A (published on Jul. 22, 2004.

### DISCLOSURE

### Technical Problem

Therefore, the present invention has been made in view of the above problems, and it is one object of the present invention to provide a flame-retardant decorative flooring material wherein at least one of layers constituting the flame-retardant decorative flooring material includes a polyvinyl acetal resin, thereby providing safety and superior flame retardancy by reducing the density of flame and toxic gases generated by combustion of resin in case of fire.

### Technical Solution

In accordance with one aspect of the present invention, provided is a flame-retardant decorative flooring material, including a lower layer; a base layer; a printed layer; and a transparent layer sequentially from bottom to top, wherein at least any one of the layers includes a polyvinyl acetal resin.

In accordance with another aspect of the present invention, there is provided A method of manufacturing a flame-retardant decorative flooring material including a lower layer; a base layer; a printed layer; and a transparent layer sequentially from bottom to top, the method including:

(1) a lower layer preparation step of preparing a lower layer using a composition including 100 parts by weight of a polyvinyl acetal resin and 100 to 400 parts by weight of a filler based on 100 parts by weight of the polyvinyl acetal resin;

(2) a base layer preparation step of preparing a base layer composed of glass fiber that is immersed in a PVC sol;

(3) a printing step of forming a printed layer by printing a pattern on the base layer or laminating the base layer with a pattern-printed film or paper;

(4) a transparent layer preparation step of preparing a transparent layer composed of a transparent PVC film or a PET film; and

(5) a lamination step of disposing the base layer including the printed layer formed thereon between the lower layer and the transparent layer and laminating the same.

### Advantageous Effects

As apparent from the fore-going, the present invention advantageously provides a flame-retardant decorative flooring material providing safety and superior flame retardancy by reducing the density of flame and toxic gases generated by combustion of resin in case of fire.

### DESCRIPTION OF DRAWINGS

FIG. 1 illustrates a sectional view of a conventional decorative flooring material.

FIG. 2 illustrates a sectional view of a flame-retardant decorative flooring material according to an embodiment of the present invention.

FIG. 3 is a schematic diagram illustrating a process of manufacturing a flame-retardant decorative flooring material according to an embodiment of the present invention.

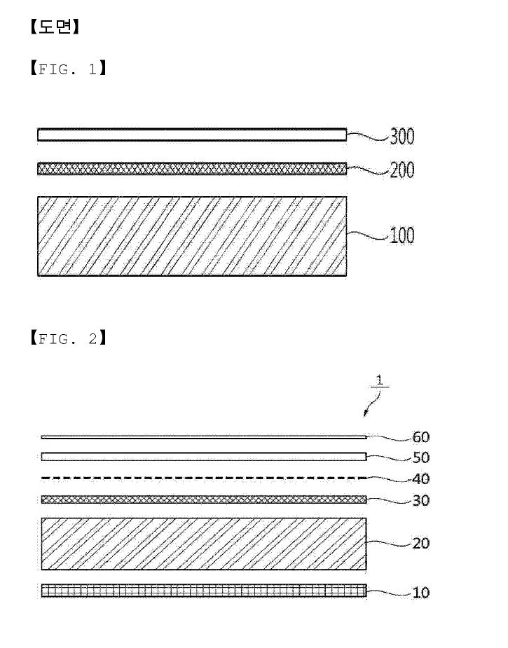

### DESCRIPTION OF SYMBOLS

1: Flame-retardant decorative flooring material
10: Additional functional layer
20: Lower layer
30: Base layer
40: Print layer
50: Transparent layer
60: Surface treatment layer

### BEST MODE

Hereinafter, the present invention is described in detail with reference to the accompanying drawings.

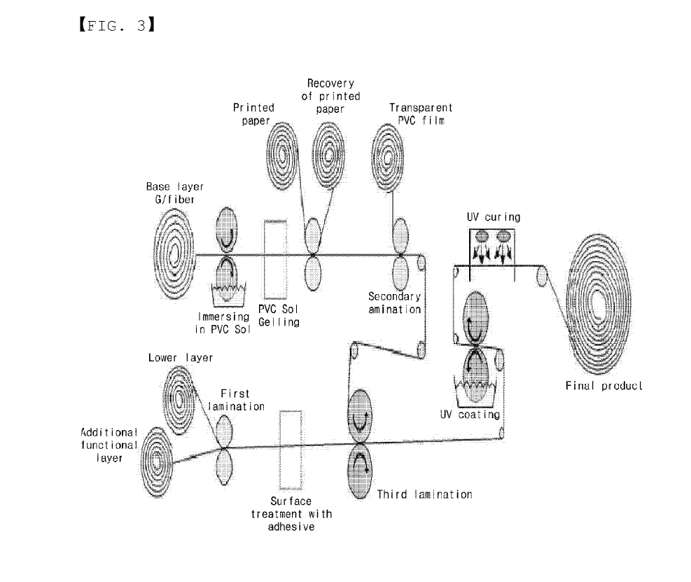

The present invention relates to a flame-retardant decorative flooring material including a lower layer 20; a base layer 30; a printed layer 40; and a transparent layer 50 sequentially from bottom to top, wherein at least any one of the layers includes a polyvinyl acetal resin (see FIG. 2).

At least any one of the layers constituting the flame-retardant decorative flooring material of the present invention includes a polyvinyl acetal resin, thereby providing flame retardancy to the decorative flooring material.

The polyvinyl acetal resin is prepared by acetalizing a polyvinyl alcohol-based resin with an aldehyde compound. A polyvinyl alcohol-based resin used as a raw material of a polyvinyl acetal resin may be obtained by, for example, polymerizing a vinyl ester-based monomer and saponifying an obtained polymer. As a method of polymerizing a vinyl ester-based monomer, a conventionally known method, such as a solution polymerization method, a bulk polymerization method, a suspension polymerization method, or an emulsion polymerization method, may be used. As a polymerization initiator, an azo-based initiator, a peroxide-based initiator, a redox-based initiator, or the like is suitably selected depending upon a polymerization method. For saponification, conventionally known alcoholysis, hydrolysis, or the like using an alkali catalyst or an acid catalyst may be applied. Thereamong, saponification using methanol, as a solvent, and a caustic soda catalyst is convenient and most preferred. A saponification degree of a polyvinyl alcohol-based resin used in the present invention is not specifically limited, but is preferably 95 mol % or more, more preferably 98 mol % or more.

As the vinyl ester-based monomer, for example, vinyl formate, vinyl acetate, vinyl propionate, vinyl butyrate, isovinyl butyrate, vinyl pivalate, vinyl versatate, vinyl caprate, vinyl caprylate, vinyl laurate, vinyl palmitate, vinyl stearate, vinyl oleate, benzoate, or the like may be used. In particularly, vinyl acetate is preferred.

In addition, when the vinyl ester-based monomer is polymerized, the vinyl ester-based monomer may be copolymerized with another monomer within a range within the resin of the present invention is not damaged. As an example of another monomer, there is an α-olefin such as ethylene, propylene, n-butene, or isobutylene, acrylic acid or a salt thereof, an acrylic ester such as methyl acrylate, ethyl acrylate, n-propyl acrylate, i-propyl acrylate, n-butyl acrylate, i-butyl acrylate, t-butyl acrylate, 2-ethylhexyl acrylate, dodecyl acrylate, or octadecyl acrylate, a methacrylic acid ester such as methacrylic acid or a salt thereof, methyl methacrylate, ethyl methacrylate, n-propyl methacrylate, i-propyl methacrylate, n-butyl methacrylate, i-butyl methacrylate, t-butyl methacrylate, 2-ethylhexyl methacrylate, dodecyl methacrylate, or octadecyl methacrylate, an acrylamide derivative such as acrylamide, N-methylacrylamide, N-ethylacrylamide, N-dimethylacrylamide, diacetoneacrylamide, acrylamide propanesulfonic acid or a salt thereof, acrylamide propyldimethylamine or a salt thereof or a quaternary salt thereof, or N-methylol methacrylamide or a derivative thereof, a methacrylamide derivative such as methacrylamide, N-methylmethacrylamide, N-ethylmethacrylamide, methacrylamide propanesulfonic acid and a salt thereof, methacrylamide propyldimethylamine or a salt thereof or a quaternary salt thereof, or N-methylol methacrylamide or a derivative thereof, a vinyl ether such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, or stearyl vinyl ether, a nitrile such as acrylonitrile or methacrylonitrile, a vinyl halide such as vinyl chloride or vinyl fluoride, a vinylidene halide such as vinylidene chloride or vinylidene fluoride, an allyl compound such as allyl acetate, allyl chloride, maleic acid or a salt thereof or an ester thereof or an anhydride thereof, a vinylsilyl compound such as vinyltrimethoxysilane, isopropenyl acetate, or the like. The units of these monomers are generally less than 20 mol %, more preferably less than 10 mol %, based on a general vinyl ester-based monomer.

The vinyl ester-based monomer may be polymerized in the presence of a thiol compound such as thiolacetic acid or mercaptopropionic acid, or a chain-transfer agent.

A solvent used to prepare a polyvinyl acetal resin is not specifically limited, but water is preferred for mass production thereof in the industry. Before reaction of the polyvinyl alcohol-based resin, it is preferred to sufficiently dissolve the polyvinyl alcohol-based resin in a solvent at high temperature, for example, 90° C. or more. In addition, the concentration of an aqueous solution is preferably 5 to 40% by mass, more preferably 5 to 20% by mass, particularly 8 to 15% by mass. When the concentration is too low, productivity is poor. On the other hand, when the concentration is too high, it is difficult to perform stirring during reaction. In addition, gelation occurs due to intermolecular hydrogen bonding in a polyvinyl alcohol resin, which causes uneven reaction.

A polyvinyl acetal resin may be obtained by adding an aldehyde compound to such an aqueous polyvinyl alcohol-based resin solution and reacting the same under an acidic condition. Here, as the aldehyde compound, for example, formaldehyde, acetaldehyde, propionaldehyde, butyraldehyde, hexylaldehyde, benzaldehyde, or the like is used. Preferably, a C1 to C12 aldehyde compound is used. More preferably, a saturated C1 to C6 alkylaldehyde compound is used. Particularly, a saturated C1 to C4 alkylaldehyde compound is preferred. Thereamong, butyraldehyde is preferred in view of properties, such as flame retardancy, of a decorative flooring material. In addition, as the aldehyde compound, a single compound may be used, or two or more compounds may be combined. In addition, a multifunctional aldehyde compound, or other aldehyde compounds having a functional group may be combined in a small amount of 20% by mass or less based on a total amount of the aldehyde compound. A solvent for reaction of the aqueous polyvinyl alcohol-based resin solution with an aldehyde compound is not specifically limited, and may be any one of an organic acid and an inorganic acid. For example, the solvent may be acetic acid, para-toluenesulfonic acid, nitric acid, sulfuric acid, hydrochloric acid, carbonic acid, or the like. Thereamong, an inorganic acid is preferred. Particularly, hydrochloric acid, sulfuric acid, and nitric acid are preferred in that a sufficient reaction rate may be obtained and washing after reaction is easy. The concentration used for the reaction depends upon the kind of acid used, but, in the cases of hydrochloric acid, sulfuric acid, and nitric acid, a concentration of 0.01 to 5 mol/l is preferred and a concentration of 0.1 to 2 mol/l is more preferred. When the concentration of an acid is too low, a reaction rate is low and it takes time to obtain a desired acetalization degree and a polyvinyl acetal resin having desired properties. On the other hand, when the concentration of an acid is too high, it is difficult to control reaction and a trimer of aldehyde is easily generated.

As an example of a method of reacting the aqueous polyvinyl alcohol-based resin solution with an aldehyde compound, there are publicly known methods such as, for example, a method of adding the catalyst to the aqueous polyvinyl alcohol-based resin solution and then adding an aldehyde compound thereto and a method of previously adding an aldehyde compound and then an acid catalyst thereto. In addition, there is a method such as a method of adding an aldehyde compound or an acid catalyst batchwise, sequentially, or portionwise or a method of adding a mixture of an aqueous polyvinyl alcohol-based resin solution and an aldehyde compound or an acid catalyst to a solution including an acid catalyst or an aldehyde compound.

Reaction temperature is not specifically limited, but is preferably 0 to 80° C. To obtain the layer used in the flame-retardant decorative flooring material of the present invention, a porous polyvinyl acetal resin, which is easily cleaned after reaction, is preferred. Until polyvinyl acetal particles are precipitated during the reaction, the reaction is performed at a relatively low temperature of 0 to 40° C., preferably 5 to 20° C. Subsequently, to accelerate the reaction, it is preferred to increase a reaction temperature. The increased reaction temperature is, for example, 50 to 80° C. Particularly, the increased reaction temperature is preferably 65 to 75° C. in view of productivity.

Polyvinyl acetal resin particles obtained through such a reaction preferably have a porous shape so as to efficiently remove a remaining acid, a remaining aldehyde compound, or the like. To obtain the porous polyvinyl acetal resin particles, it is required to adjust the viscosity of a reaction liquid, a stirring speed, the shape of an impeller, the shape of a reaction vessel, reaction temperature, reaction rate, and a method of adding a catalyst and aldehydes. For example, when a reaction temperature is too high, a polyvinyl acetal-based resin is fused, whereby it is difficult to form a porous shape.

To remove a remaining aldehyde compound and a remaining acid catalyst after the reaction, publicly known methods may be used. Since a polyvinyl acetal resin is decomposed by an acid in the presence of water to generate an aldehyde compound, it is preferred to adjust an alkali titer to a positive value. Here, the expression “alkali titer” refers to a value (ml) defined by the amount of 0.01 mol/l hydrochloric acid required for alkali titration of 100 g of a polyvinyl acetal resin. That is, although the polyvinyl acetal resin obtained by the reaction is neutralized with an alkali compound, it is preferred to remove an aldehyde compound remaining in the resin before alkali neutralization so as to obtain the layers of the flame-retardant decorative flooring material of the present invention. In addition, a method of accelerating a reaction under the condition under which a reaction rate of an aldehyde compound increases, a method of sufficiently washing with water or a solvent mixture of water and alcohol, a method of chemically treating an aldehyde compound, and the like are useful. As an alkali compound used in alkali neutralization, for example, a hydroxide of an alkali metal such as sodium hydroxide or potassium hydroxide, an amine-based compound such as ammonia, triethylamine, or pyridine, or the like may be used. A hydroxide of an inorganic metal is preferred in view of coloring, and an alkali metal hydroxide hardly affecting adhesion to glass is particularly preferred. In addition, an alkali titer of the polyvinyl acetal resin, after alkali washing, is preferably 0.1 to 30, more preferably 1 to 20. When the alkali titer is too low, resistance to hydrolysis is decreased. On the other hand, when the alkali titer is too high, coloring may easily occur when the layers of the decorative flooring material are manufactured.

An average polymerization degree of the polyvinyl acetal resin used in the present invention is preferably 800 to 4000, more preferably 1,000 to 3,000. In addition, an average acetalization degree (vinyl acetal unit content), which is measured in accordance with the regulations of JIS K6728, 1977, of the polyvinyl acetal resin is preferably 50 to 90 mol %, more preferably 55 to 88 mol %, particularly preferably 60 to 85 mol %.

A vinyl alcohol unit amount, which is measured in accordance with the regulations of JIS K6728, 1977, of the polyvinyl acetal resin used in the present invention is preferably 10 to 50 mol %, more preferably 12 to 45 mol %, even more preferably 15 to 40 mol %. When the vinyl alcohol unit amount is higher than 50 mol %, hygroscopicity increases. Due to the absorbed water, metal corrosion, insulating property decrease, or peeling of a layer using the polyvinyl acetal resin from another layer may occur. Meanwhile, when the vinyl alcohol unit amount is less than 10 mol %, problems such as mechanical strength decrease and poor adhesion may occur upon hot pressing.

A vinyl ester unit amount, which is measured in accordance with the regulations of JIS K6728, 1977, of the polyvinyl acetal resin used in the present invention is preferably 4 mol % or less, more preferably 2 mol % or less, even more preferably 1 mol % or less. When the vinyl acetate unit amount is greater than 4 mol %, acetic acid, as a corrosive substance, may occur due to decomposition by heat, hydrolysis by water. In addition, due to olefin generation by desorption of acetic acid, the polyvinyl acetal resin may be easily colored. In addition, the acetalization degree, the vinyl alcohol unit amount, and the vinyl ester unit amount are values relative to the sum of the acetalization degree (vinyl acetal unit content), the vinyl alcohol unit amount, and the vinyl ester unit amount.

The polyvinyl acetal-based resin used to manufacture the flame-retardant decorative flooring material of the present invention may include additives such as a filler, a plasticizer, an antioxidant, an ultraviolet absorber, an adhesion regulator, an antiblocking agent, a pigment, a dye, and a functional inorganic compound as needed within a range within which a resultant decorative flooring material does not negatively affect the effects of the present invention.

Meanwhile, in the decorative flooring material of the present invention, it is preferred that the lower layer being thicker and heavier than the other layers essentially include a polyvinyl acetal resin. Here, the other layers, i.e., the base layer 30, the printed layer 40, the transparent layer 50, and the like, may be manufactured selectively using another synthetic resin (see FIG. 2).

In a particular embodiment, the lower layer 20 includes a polyvinyl acetal resin, and, in the base layer 30, the transparent layer 50, and the like, another synthetic resin, such as a PVC, may be used.

The lower layer 20 may include a filler to increase strength, flame retardancy, and durability and reduce manufacturing costs. The filler may include one or more selected from the group consisting of calcium carbonate, talc, fly ash, blast furnace slag, and a combination thereof. The filler may be isotropic. In this case, particles having suitable sizes may be selectively used in consideration of both economic effects and property improvement effects. In particular, as the filler, calcium carbonate, which is advantageous in terms of price and versatility and may improve flame retardancy and durability, is preferred. The lower layer may include 100 to 400 parts by weight, preferably 130 to 350 parts by weight, of a filler based on 100 parts by weight of the polyvinyl acetal resin. When the content of the filler is less than 100 parts by weight, the cost of the decorative flooring material may increase and properties such as flame retardancy may be deteriorated. When the content of the filler is greater than 400 parts by weight, the processability of the decorative flooring material may be decreased when used. Accordingly, it is preferred to include the filler within the range. The thickness of the lower layer 20 may be 1 to 2 mm.

The base layer 30 reinforces the dimensional stability of the decorative flooring material. The base layer 30 is formed of glass fiber immersed in a PVC sol, preferably a glass fiber nonwoven fabric. In this case, impregnation in a PVC sol may be understood as being performed to fix glass fiber and, at the same time, facilitate laminating between the base layer 30 and the lower layer 20. Here, the PVC sol preferably includes 100 parts by weight of polyvinyl chloride having a polymerization degree of 1000 to 1700, 50 to 100 parts by weight of dioctylterephthalate (DOTP) or dioctylphthlate (DOP) as a plasticizer, 1 to 3 parts by weight of epoxidized soybean oil, 2 to 6 parts by weight of a barium-zinc based heat stabilizer, 10 to 80 parts by weight of calcium carbonate, and 5 to 50 parts by weight of titanium dioxide as a white pigment. The thickness of the base layer 30 may be 0.30 to 0.40 mm.

The printed layer 40 provides a variety of print patterns to an obtained decorative flooring material. Here, the printed layer 40 may be formed on the base layer 30 by transfer printing, gravure printing, or screen printing, preferably transfer printing. Alternatively, a film or paper having a pattern thereon may be laminated with the base layer. The printed layer 40 imparts a pattern through printing and provides an aesthetically superior appearance and design.

The transparent layer 50 may be manufactured using any one selected from among polyvinyl chloride (PVC), polyethylene terephthalate (PET), polybutylene terephthalate, (PBT), polypropylene (PP), polyethylene (PE), polymethyl methacrylate (PMMA), acrylonitrile-butadiene-styrene (ABS), polycarbonate (PC), and a styrene-acrylonitrile copolymer (SAN). Preferably, a transparent polyvinyl chloride film or transparent polyethylene terephthalate film having superior transparency is used. The transparent layer may have a thickness of 0.1 to 0.7 mm.

Meanwhile, the flame-retardant decorative flooring material of the present invention may further, selectively include the surface treatment layer 60 on the topmost layer thereof.

That is, the surface treatment layer 60 may be formed on an upper part of the transparent layer, may prevent a surface of the decorative flooring material from initial contamination, and may improve scratch resistance and abrasion resistance. The surface treatment layer may be formed by coating with a coating liquid that is prepared by dissolving a thermosetting or photocurable compound in a solvent. However, in the case of a thermosetting compound, the properties of other layers, particularly an elastic layer, located at a lower part of the surface treatment layer may be changed when heat is applied to form the surface treatment layer. Accordingly, it is more preferred to use a photocurable compound. Here, as the curable compound, a monomer or oligomer having one or more functional groups, such as an unsaturated bond group capable of performing crosslinking reaction, may be used. As such a monomer or oligomer, urethane acrylate, epoxy acrylate, polyether acrylate, polyester acrylate, dipentaacrythritol hexaacrylate, dipentaerythritol tetraacrylate, pentaacrythiotol tetraacrylate, dipentaerythritol hexaacrylate, dipentaerythritol pentaacrylate, or the like may be used. However, these substances are only provided as examples and it is not intended to limit the present invention thereto. In the present invention, only one of these substances or a mixture of two or more thereof may be used as a photocurable compound. A coating liquid including the photocurable compound generally includes, other than the photocurable compound and a solvent, a photopolymerization initiator. As needed, a variety of additives, such as a light stabilizer and a leveling agent, may be included within a range within which the properties of a hard coating layer are not changed. The surface treatment layer may have a surface hardness of 7 H or more measured by a pencil hardness measurement method, whereby a surface hardness of a plastic film may be superior. More preferably, a surface hardness of the surface treatment layer is adjusted to 7 H to 8 H. The photocurable compound constituting the surface treatment layer 60 is preferably a general photocurable urethane acrylate. The surface treatment layer 60 may have a thickness of 5 to 40 μm.

Meanwhile, the flame-retardant decorative flooring material of the present invention may selectively include an additional functional layer 10 on the bottommost layer thereof.

The additional functional layer 10 may be made of a general woven fabric, knitted fabric, or nonwoven fabric. The woven fabric, the knitted fabric, or the nonwoven fabric may be a woven fabric woven from a natural fiber or a synthetic fiber or a mixed fiber thereof, a knitted fabric, or a nonwoven fabric produced by a known processing method such as needle punching. The additional functional layer 10 enhances the quality of a final product and the market value thereof by improving the appearance of the decorative flooring material, particularly the appearance of a back surface (bottom surface) of the decorative flooring material. At the same time, the additional functional layer 10 improves adhesion of the decorative flooring material to the floor, thereby facilitating installation of the decorative flooring material. The additional functional layer 10 may have a thickness of 0.1 to 1.0 mm.

In addition, the present invention provides a method of manufacturing the flame-retardant decorative flooring material including the lower layer; the base layer; the printed layer; and the transparent layer sequentially from bottom to top, the method including:

(1) a lower layer preparation step of preparing a lower layer using a composition including 100 parts by weight of a polyvinyl acetal resin and 100 to 400 parts by weight of a filler based on 100 parts by weight of the polyvinyl acetal resin;

(2) a base layer preparation step of preparing a base layer composed of glass fiber that is immersed in a PVC sol;

(3) a printing step of forming a printed layer by printing a pattern on the base layer or laminating the base layer with a pattern-printed film or paper;

(4) a transparent layer preparation step of preparing a transparent layer composed of a transparent PVC film or a PET film; and

(5) a lamination step of disposing the base layer including the printed layer formed thereon between the lower layer and the transparent layer and laminating the same.

In the lower layer preparation step, the polyvinyl acetal resin is prepared by acetalizing a polyvinyl alcohol-based resin with an aldehyde compound. The polyvinyl acetal resin used in the present invention has been described in detail above, and thus, a description thereof is omitted.

The base layer preparation step is a step of gelling glass fiber that is immersed in a PVC sol. The glass fiber is preferably formed of a glass fiber nonwoven fabric.

The printing step is a step of providing a pattern on the base layer by gravure printing, screen printing, or transfer printing to form a printed layer or laminating a pattern-printed film or paper.

The transparent layer preparation step is a step of preparing a transparent film made of a transparent synthetic resin composition, preferably a transparent PVC film or a transparent PET film.

The lamination step is a step of laminating such that a base layer including a printed layer formed thereon is located between the lower layer and the transparent layer.

After the lamination step, a surface treatment step of coating an upper part of the transparent layer with a photocurable composition and curing the photocurable composition by irradiating the photocurable composition with ultraviolet light to form a surface treatment layer may be further included.

Selectively, before the lamination step, an additional functional layer formed of a woven fabric, a knitted fabric, or a nonwoven fabric may be separately prepared and is previously laminated with the lower layer.

The method of manufacturing the flame-retardant decorative flooring material of the present invention may be summarized as follows (see FIG. 3).

Each of the lower layer and the transparent layer, except for the surface treatment layer, the printed layer, the base layer, and the additional functional layer, among the layers constituting the flame-retardant decorative flooring material of the present invention may be manufactured using calender molding, casting molding, blow molding, extrusion molding, or the like.

Calender molding is a method of continuously producing a sheet or a film by rolling a raw material between two or more rolls rotating in mutually opposite directions, casting molding is a method of coating multiple layers of synthetic resin sol on a release paper that is easy to peel off and laminating the same, blow molding is a method of heating and melting a thermoplastic resin, producing one or two or more parisons by extruding the thermoplastic resin into a tube shape by means of an extruder, inserting the extruded parisons into one or two or more molds, closing doors, sealing the top and bottom of the mold, and blowing air into the parisons in a mandrel to expand the parisons such that the parisons closely contact the inner wall of the mold, so as to manufacture a hollow container, and extrusion molding is a method of heating and melting a thermoplastic plastic material on the surface of a substrate by means of an extruder to be in a fluidized state and then extruding the same into a film using a T die and simultaneously pressing the same.

Thereamong, calender molding is preferred because the contents of ingredients such as additives may be freely controlled, which allows provision of a decorative flooring material having superior flexibility, impact resistance, mechanical strength, processability, fitness, and melting efficiency, compared to other manufacturing methods, and further reduces the cost of raw materials.

Among the layers manufactured as described above, first, the additional functional layer (selectively applicable) is laminated (first lamination) on a lower surface of the lower layer from the bottom.

In addition, a glass fiber nonwoven fabric is immersed in a PVC sol and gelling is completed, thereby preparing the base layer.

Subsequently, the printed layer is formed by forming a pattern on the base layer by a general printing method, for example, gravure printing, screen printing, or transfer printing, or the printed layer is formed by laminating a pattern-printed film or paper.

Subsequently, the transparent layer is laminated on the base layer on which the printed layer is formed (secondary lamination).

After independently laminating the layers constituting an upper part and lower part of the decorative flooring material, an upper surface of the lower layer and a lower surface of the base layer are disposed to face each other and then laminated together (third lamination).

The first, secondary, and third lamination methods may be performed using adhesive application and/or thermocompression.

After laminating the layers together, the laminated layers are cooled. Optionally, an upper surface of the transparent layer is coated with preferably a coating liquid, which is prepared by dissolving a photocurable compound in a solvent, by means of a coating machine and the coating liquid is cured by irradiating the photocurable composition with ultraviolet light, thereby forming a surface treatment layer. Accordingly, a final product, i.e., a flame-retardant decorative flooring material is obtained.

Now, the present invention will be described in more detail with reference to the following preferred examples. However, these examples are provided for illustrative purposes only. Those skilled in the art will appreciate that various modifications, additions and substitutions are possible, without departing from the scope and spirit of the invention. Therefore, it is obvious that the modifications, additions and substitutions are within the scope of the present invention.

### EXAMPLE

### Example 1

A transparent layer having a thickness of 0.2 mm was manufactured by calender molding using a composition including a PVC resin.

In addition, a composition including 100 parts by weight of polyvinyl butyral as a polyvinyl acetal resin and 150 parts by weight of calcium carbonate as a filler was calender-molded, thereby manufacturing a lower layer having a thickness of 1.5 mm.

A glass fiber sheet (30 g/m²) was immersed in a PVC sol that included 100 parts by weight of polyvinyl chloride having a polymerization degree of 1000, 60 parts by weight of dioctylphthlate, 100 parts by weight of calcium carbonate, and 2 parts by weight of a barium-zinc based heat stabilizer and dried, thereby manufacturing a base layer. Subsequently, a pattern was provided onto an upper part on the base layer by gravure printing, thereby forming a printed layer.

Subsequently, the base layer including the printed layer thereon and a transparent layer were thermo-compressed. Subsequently, a lower surface of the base layer and an upper surface of a lower layer were disposed to face each other and thermo-compressed. Subsequently, a glossy urethane acrylate-based UV-curable resin was spread onto the entire surface by a roll coating method, and then ultraviolet light was irradiated, thereby manufacturing a flame-retardant decorative flooring material having a surface treatment layer thereon.

### Example 2

The composition of the lower layer of Example 1 was changed as follows.

A composition including 100 parts by weight of polyvinyl butyral as a polyvinyl acetal resin and 300 parts by weight of calcium carbonate as a filler was calender-molded, thereby manufacturing a lower layer having a thickness of 1.5 mm. The compositions and processing methods of the other layers were the same as in Example 1.

### Comparative Example 1

The composition of the lower layer of Example 1 was changed as follows.

A composition prepared by adding 100 parts by weight of calcium carbonate, 40 parts by weight of dioctylphthlate, and 2 parts by weight of a barium-zinc based heat stabilizer to 100 parts by weight of PVC was calender-molded, thereby manufacturing a lower layer having a thickness of 1.5 mm. The compositions and processing methods of the other layers were the same as in Example 1.

### Comparative Example 2

The composition of the lower layer of Example 1 was changed as follows.

A composition prepared by adding 300 parts by weight of calcium carbonate, 55 parts by weight of dioctylphthlate, and 2 parts by weight of a barium-zinc based heat stabilizer to 100 parts by weight of PVC was calender molded, thereby manufacturing a lower layer having a thickness of 1.5 mm. The compositions and processing methods of the other layers were the same as in Example 1.

### Experimental Example 1

Smoke density, toxic gases, and flame propagation of the decorative flooring material manufactured according to each of Examples 1 and 2 and Comparative Examples 1 and 2 were measured. Results are summarized in Table 1 below.

Smoke density and toxic gases were measured in accordance with the ISO 5659-2 combustion chamber test method.

TABLE 1

| | | | | Flame |
|---|---|---|---|---|
| | Smoke density | Toxic gases | | propagation |
| Item | 50 kw non flame | HCl | CO | Critic Flux |
| Standard | <500 ppm | <600 ppm | <1450 ppm | >7 W/m² |
| Comparative | 924 | 870 | 2518 | 8.0 |
| Example 1 | | | | |
| Comparative | 784 | 656 | 1623 | 8.6 |
| Example 2 | | | | |
| Example 1 | 390 | 300 | 600 | 7.5 |
| Example 2 | 320 | 250 | 500 | 8.0 |

As shown in Table 1, can be confirmed that, in the cases of the flame-retardant decorative flooring materials (Examples 1 and 2) according to the present invention, smoke density was reduced by up to about one third and hydrogen chloride and carbon monoxide, among toxic gases, were respectively reduced by up to about one third, compared to Comparative Examples. In addition, it can be confirmed that, in the cases of the flame-retardant decorative flooring materials (Examples 1 and 2) according to the present invention, flame propagation is maintained at the same level as conventional PVC decorative flooring materials.

Therefore, the flame-retardant decorative flooring material according to the present invention provides safety and superior flame retardancy by reducing the density of flame and toxic gases generated by combustion of resin in case of fire.

1. A flame-retardant decorative flooring material, comprising a lower layer; a base layer; a printed layer; and a transparent layer sequentially from bottom to top, wherein at least any one of the layers comprises a polyvinyl acetal resin.

2. The flame-retardant decorative flooring material according to claim 1, wherein the polyvinyl acetal resin is prepared by acetalizing a polyvinyl alcohol-based resin with an aldehyde compound.

3. The flame-retardant decorative flooring material according to claim 2, wherein the polyvinyl alcohol-based resin is prepared by polymerizing one or more selected from a vinyl ester-based monomer group consisting of vinyl formate, vinyl acetate, vinyl propionate, vinyl butyrate, isovinyl butyrate, vinyl pivalate, vinyl versatate, vinyl caprate, vinyl caprylate, vinyl laurate, vinyl palmitate, vinyl stearate, vinyl oleate, and benzoate and then saponifying the same.

4. The flame-retardant decorative flooring material according to claim 3, wherein the vinyl ester-based monomer is vinyl acetate.

5. The flame-retardant decorative flooring material according to claim 2, wherein the aldehyde compound is one or more selected from the group consisting of formaldehyde, acetaldehyde, propionaldehyde, butyraldehyde, hexylaldehyde, and benzaldehyde.

6. The flame-retardant decorative flooring material according to claim 5, wherein the aldehyde compound is butyraldehyde.

7. The flame-retardant decorative flooring material according to claim 1, wherein the polyvinyl acetal resin has an average polymerization degree of 800 to 4000.

8. The flame-retardant decorative flooring material according to claim 1, wherein the polyvinyl acetal resin has a vinyl alcohol unit amount of 10 to 50 mol %.

9. The flame-retardant decorative flooring material according to claim 1, wherein the polyvinyl acetal resin has a vinyl ester unit amount of 4 mol % or less.

10. The flame-retardant decorative flooring material according to claim 1, wherein the polyvinyl acetal resin comprises one or more selected from a group consisting of a filler, a plasticizer, an antioxidant, an ultraviolet absorber, an adhesion regulator, an antiblocking agent, a pigment, a dye, and a functional inorganic compound.

11. The flame-retardant decorative flooring material according to claim 1, wherein the lower layer comprises 100 parts by weight of a polyvinyl acetal resin and 100 to 400 parts by weight of a filler based on 100 parts by weight of the polyvinyl acetal resin.

12. The flame-retardant decorative flooring material according to claim 1, wherein the lower layer has a thickness of 1 to 2 mm.

13. The flame-retardant decorative flooring material according to claim 1, wherein the base layer is glass fiber immersed in a PVC sol.

14. The flame-retardant decorative flooring material according to claim 1, wherein the printed layer is an ink layer formed by transfer printing, gravure printing, or screen printing or a pattern-printed film or paper.

15. The flame-retardant decorative flooring material according to claim 1, wherein the transparent layer is a transparent PVC film or a transparent PET film.

16. The flame-retardant decorative flooring material according to claim 1, wherein the flame-retardant decorative flooring material further comprises a surface treatment layer formed on the transparent layer.

17. The flame-retardant decorative flooring material according to claim 16, wherein the surface treatment layer is formed by coating with a coating liquid that is prepared by dissolving a thermosetting or photocurable compound in a solvent.

18. The flame-retardant decorative flooring material according to claim 1, wherein the flame-retardant decorative flooring material further comprises an additional functional layer formed on a lower part of the lower layer.

19. The flame-retardant decorative flooring material according to claim 18, wherein the additional functional layer is formed of a woven fabric, a knitted fabric, or a nonwoven fabric.

20. A method of manufacturing a flame-retardant decorative flooring material comprising a lower layer; a base layer; a printed layer; and a transparent layer sequentially from bottom to top, the method comprising:
(1) a lower layer preparation step of preparing a lower layer using a composition comprising 100 parts by weight of a polyvinyl acetal resin and 100 to 400 parts by weight of a filler based on 100 parts by weight of the polyvinyl acetal resin;
(2) a base layer preparation step of preparing a base layer composed of glass fiber that is immersed in a PVC sol;
(3) a printing step of forming a printed layer by printing a pattern on the base layer or laminating the base layer with a pattern-printed film or paper;
(4) a transparent layer preparation step of preparing a transparent layer composed of a transparent PVC film or a PET film; and
(5) a lamination step of disposing the base layer comprising the printed layer formed thereon between the lower layer and the transparent layer and laminating the same.

21. The method according to claim 20, wherein the polyvinyl acetal resin is prepared by acetalizing a polyvinyl alcohol-based resin with an aldehyde compound.

22. The method according to claim 20, further comprising, after the lamination step, a surface treatment step of coating an upper part of the transparent layer with a photocurable composition and curing the photocurable composition by irradiating the photocurable composition with ultraviolet light to form a surface treatment layer.

23. The method according to claim 20, wherein, before the lamination step, an additional functional layer formed of a woven fabric, a knitted fabric, or a nonwoven fabric is separately prepared and is previously laminated with the lower layer.
